(19) United States
(12) Patent Application Publication
(10) Pub. No.: US 2026/0288175 A1
(43) Pub. Date: Sep. 24, 2026

(54) VEHICLE AND METHOD FOR CONTROLLING SAME

(71) Applicants: HYUNDAI MOTOR COMPANY, Seoul (KR); KIA CORPORATION, Seoul (KR)

(72) Inventor: Jun Ho LEE, Hwaseong-si (KR)

(21) Appl. No.: 19/570,684

(22) Filed: Mar. 18, 2026

(30) Foreign Application Priority Data
Mar. 19, 2025 (KR) 10-2025-0035079

(51) Int. Cl. G05D 1/81; B60W 50/14; B60W 60/00; B60W 50/00

(52) U.S. Cl. CPC G05D 1/81; B60W 50/14; B60W 60/0053; B60W 2050/0026; B60W 2554/4046

(57) ABSTRACT

Disclosed herein a vehicle and method for cotrolling same. The vehicle includes: a sensor unit that detects object state and vehicle state around the vehicle; a memory that stores at least one command; and at least one processor that executes the at least one command stored in the memory. The at least one processor is configured to: generate a vehicle control command that controls an actuator of the vehicle based on object state and vehicle state around the vehicle; and determine whether the vehicle control command meets an allowable control command set depending on the object state and the vehicle state; and control the actuator of the vehicle depending on the allowable control command based on the vehicle control command not meeting the allowable control command,.

### CROSS-REFERENCE TO RELATED APPLICATION

This application claims the benefit of priority to Korean Patent Application No. 10-2025-0035079, filed in the Korean Intellectual Property Office on Mar. 19, 2025, the disclosure of which is incorporated herein by reference in its entirety.

### TECHNICAL FIELD

The present disclosure relates to a vehicle and a method for controlling the same, and more specifically, to a vehicle that ensures safe driving control with few resources before control switching by manual driving in an abnormal situation of autonomous driving control, and a method for controlling the same.

### BACKGROUND

The matters described in this Background section are only for enhancement of understanding of the background of the disclosure, and should not be taken as acknowledgment that they correspond to prior art already known to those skilled in the art.

Vehicles are commercialized with various functions for driving convenience. To this end, an autonomous driving system is supported in vehicles. The autonomous driving system is developed so that the vehicle controls driving without user intervention.

The autonomous driving system aims to recognize the surrounding environment, plan a driving path by the vehicle itself, and drive safely. The autonomous driving system may be configured to perform recognition, establishment of a driving plan, and control. The recognition process may detect the surrounding environment of the vehicle through a sensor. The determination process may determine the driving path based on information recognized by the sensor. The control process may control an actuator to drive the vehicle according to the path.

The autonomous driving system requires a high level of safety. A malfunction of the autonomous driving system may cause serious damage. Ensuring safety is a factor considered in developing the autonomous driving system.

### SUMMARY

The various examples of the present disclosure provide a vehicle that ensures safe driving control with few resources before control switching by manual driving in an abnormal situation of autonomous driving control, and a method for controlling the same.

The various examples to be achieved by the present disclosure are not limited to the above-mentioned technical problems, and other technical problems that are not mentioned will be clearly understood by those skilled in the art to which the present disclosure belongs from the description below.

According to the present disclosure, a vehicle may comprise a sensor configured to detect object state and vehicle state associated with the vehicle, a processor, and a memory storing at least one instruction that, when executed by the processor, is configured to cause the vehicle to generate, based on the object state and vehicle state, a vehicle control command that controls an actuator of the vehicle, determine, based on the object state and vehicle state, whether the vehicle control command corresponds to at least one allowable control command of an allowable control command set, based on the vehicle control command not corresponding to any allowable control command of the allowable control command set, output a signal associated with an allowable control command, and control, based on the signal, the actuator of the vehicle.

The object state may comprise object data related to at least one behavior state of an object associated with a surrounding environment of the vehicle, and the vehicle state may comprise operation data related to at least one operational state of the vehicle. The object state may comprise a relative position of the object with respect to the vehicle and a relative velocity of the object with respect to the vehicle, and the vehicle state may comprise a longitudinal operational state of the vehicle and a transverse operational state of the vehicle.

The allowable control command may be determined using a preset lookup table, and the preset lookup table may be indexed by a value of the object state and a value of the vehicle state to provide a control command value. The object state may comprise object data related to at least one behavior state of an object associated with a surrounding environment of the vehicle, the vehicle state may comprise operation data related to at least one operational state of the vehicle, priority data based on a control type of the actuator may be selected among the object data and the operation data, a predetermined range of margin may be applied to the priority data, and the allowable control command may be determined based on the priority data with the applied predetermined range of margin and may be defined as a control command range having an upper limit value of the allowable control command and a lower limit value of the allowable control command.

The at least one instruction, when executed by the processor, may be configured to cause the vehicle to, based on a first value associated with the vehicle control command exceeding the upper limit value of the allowable control command, control the actuator using the upper limit value, and based on a second value associated with the vehicle control command being less than the lower limit value of the allowable control command, control the actuator using the lower limit value.

The allowable control command may be provided as a control command range having an upper limit value and a lower limit value by applying a margin of a predetermined range to the control command value. The at least one instruction, when executed by the processor, may be configured to cause the vehicle to, after the control of the actuator of the vehicle, determine whether the control of the vehicle has been switched to a manual control, maintain, based on the control not being switched to the manual control, control of the actuator using the allowable control command, and perform, based on the control being switched to the manual control, the manual control of the actuator.

The vehicle control command may comprise a control command of the actuator for performing autonomous driving of the vehicle. The at least one instruction, when executed by the processor, may be configured to cause the vehicle to, after the performing of autonomous driving of the vehicle, generate a message notifying of a fault in the autonomous driving and requesting a switching to a manual control of the vehicle.

According to the present disclosure, a method performed by a vehicle may comprise generating, based on object state and vehicle state associated with the vehicle, a vehicle control command that controls an actuator of the vehicle, determining, based on the object state and vehicle state, whether the vehicle control command corresponds to at least one allowable control command of an allowable control command set, based on the vehicle control command not corresponding to any allowable control command of the allowable control command set, outputting a signal associated with an allowable control command, and controlling, based on the signal, the actuator of the vehicle.

According to the present disclosure, a vehicle may comprise a sensor configured to obtain an object state associated with at least one object in a surrounding environment of the vehicle and a vehicle state of the vehicle, an actuator configured to perform at least one of steering, braking, or acceleration of the vehicle, a driving control circuit configured to control autonomous driving of the vehicle, and a processor circuit configured to generate, based on the object state and the vehicle state, a vehicle control signal for controlling the actuator of the vehicle, determine whether a value of the vehicle control signal is within an allowable control signal range that is preset based on the object state and the vehicle state, based on the value of the vehicle control signal not being within the allowable control signal range, output a signal satisfying the allowable control signal range, and control, via the driving control circuit and based on the signal, autonomous driving of the vehicle.

The processor circuit may be configured to determine the allowable control signal range by referencing a map, and the map may be generated based on control commands that are pre-determined and stored for real-time lookup of allowable commands. The processor circuit may be configured to identify, among a plurality of state variables associated with the object state and the vehicle state, a highest-priority variable having a greatest impact on the vehicle control signal, apply a margin to the highest-priority variable, and determine, based on the applied margin, the allowable control signal range. The processor circuit may be configured to output a message requesting manual driving of the vehicle and maintain control of the vehicle based on the signal until the manual driving is detected.

The features briefly summarized above for this disclosure are only exemplary examples of the detailed description of the disclosure which follow and are not intended to limit the scope of the disclosure.

### BRIEF DESCRIPTION OF THE DRAWINGS

The above and other objects, features and advantages of the present disclosure will become more apparent to those of ordinary skill in the art by describing one or more example examples thereof in detail with reference to the accompanying drawings, in which:

FIG. 1 shows an example of a vehicle communicating with another device to transmit and receive data.

FIG. 2 shows exemplary modules that constitute the vehicle.

FIG. 3 shows exemplary modules that constitute a server.

FIG. 4 shows an example of a vehicle control method.

FIG. 5 shows an example of a vehicle control process.

FIG. 6 shows an example of an allowable control command.

FIG. 7 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various different ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules,” or “units” may be combined into a smaller number of components, “modules,” or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control settings (e.g., based on at least one of an autonomous driving classification or a selected autonomous driving level for a vehicle). Based on a feature of limiting actuator commands within allowable ranges to ensure safe autonomous driving and manual takeover during faults, an operation of the vehicle may be controlled. For example, when a control signal such as braking torque or steering angle exceeds a preset allowable range, the processor may limit the corresponding actuator output to maintain safe operation and prompt the driver for manual takeover. In another example, the system may temporarily reduce acceleration commands or disable lane-change execution when sensor input uncertainty is detected.

One or more auxiliary devices (e.g., engine brake, exhaust brake, hydraulic retarder, or regenerative brake) may also be controlled based on a feature of limiting actuator commands within allowable ranges to ensure safe autonomous driving and manual takeover during faults. For example, when a braking torque or regenerative braking command exceeds a preset allowable range due to system overload or sensor error, the processor may adjust the auxiliary braking force within the safe limit to maintain vehicle stability. In another example, if such a condition persists, the system may deactivate the auxiliary braking function, activate a warning indicator, and request the driver to assume manual control.

One or more communication devices (e.g., a modem, network adapter, radio transceiver, or V2X communication module) may also be controlled based on a feature of limiting actuator commands within allowable ranges to ensure safe autonomous driving and manual takeover during faults. For example, when an actuator command such as braking or steering exceeds a preset allowable range and a fault condition is detected, the processor may control the communication device to transmit a fault notification to a server or nearby vehicles, activate emergency V2X broadcasting, or request roadside assistance. In another example, during manual takeover, the communication device may suspend non-essential communication (e.g., infotainment data transmission) to prioritize vehicle safety messages.

Minimum risk maneuver (MRM) operation(s) may also be controlled, for example, based on a feature of limiting actuator commands within allowable ranges to ensure safe autonomous driving and manual takeover during faults. For instance, when an actuator command such as braking deceleration, steering torque, or motor output exceeds a preset allowable range during autonomous driving, the processor may initiate an MRM to bring the vehicle to a safe state. In one example, if excessive braking or steering commands are detected due to sensor or control failure, the vehicle may gradually decelerate within the allowable range, activate hazard lights, and stop at a road shoulder. The system may then generate a fault notification and prompt the driver to take manual control when safe.

Biased driving operation(s) may also be controlled, for example, based on a feature of limiting actuator commands within allowable ranges to ensure safe autonomous driving and manual takeover during faults. For instance, when steering or braking commands required to maintain a biased lateral distance (e.g., for lane centering or obstacle avoidance) exceed preset allowable limits, the processor may reduce the bias amount or deactivate the biased control to prevent instability. For example, if a steering torque command for maintaining a 0.5 m offset from the lane center surpasses the allowable range under slippery road conditions, the system may limit the command to a safe threshold or return the vehicle to the lane center. If such excessive command conditions persist, the system may initiate a fault notification and prompt the driver to take manual control.

One or more sensors (e.g., IMU sensors, camera, LiDAR, RADAR, or wheel sensors) may also be controlled based on a feature of limiting actuator commands within allowable ranges to ensure safe autonomous driving and manual takeover during faults. For example, when a detected actuator command (e.g., braking pressure, steering torque, or motor current) exceeds a preset allowable range, the processor may adjust the sensor operation to enhance safety—such as increasing the sampling rate of the LiDAR or RADAR, extending the camera exposure range, or activating redundant sensors to verify abnormal readings. In another example, if the excessive actuator command persists, the sensors may trigger generation of a fault message and support a controlled switch from autonomous to manual driving.

An autonomous driving level and/or autonomous driving activation or deactivation may also be controlled based on a feature of limiting actuator commands within allowable ranges to ensure safe autonomous driving and manual takeover during faults. For example, when a control command of a brake or steering actuator exceeds an allowable range (e.g., braking deceleration greater than −3.0 m/s² or steering torque beyond a preset threshold), the driving control apparatus may automatically reduce the autonomous driving level or deactivate autonomous driving. In such a case, the vehicle may switch to a lower driving level (e.g., from Level 4 to Level 2) or prompt the driver to take manual control. Upon stabilization of the actuator state (e.g., command values returning within the allowable range), the autonomous driving level may be restored automatically or reactivated by driver confirmation.

According to the present disclosure, a vehicle and a method for controlling the same are provided to maintain safe driving when an abnormal situation occurs during autonomous driving. A processor may generate a vehicle control command based on object and vehicle states and determine whether the command falls within an allowable control range preset according to those states. When the command does not meet the allowable range, the processor may control the vehicle using the allowable command and alert the driver to take over manual control. This allows stable and safe driving control with minimal computational resources before switching from autonomous to manual driving.

Hereinafter, examples of the present disclosure will be described with reference to the accompanying drawings.

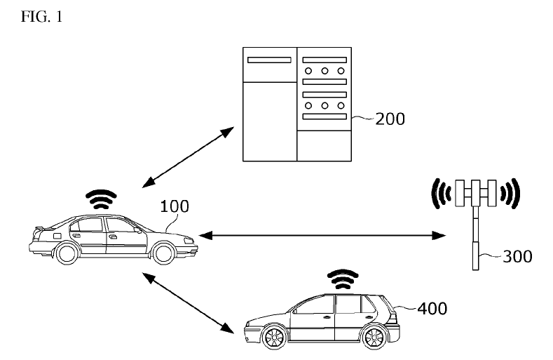

Hereinafter, a vehicle that implements autonomous driving and a server that supports the vehicle will be described with reference to FIGS. 1 to 3.

FIG. 1 shows an example of a vehicle communicating with another device to transmit and receive data.

Referring to FIG. 1, a vehicle 100 may be driven based on electric energy or fossil energy. In the case of electric energy, the vehicle 100 may employ for example, a pure battery-based vehicle (e.g., a Battery Electric Vehicle (BEV), plug-in electric car, or electric bus, etc.) driven only by a high-voltage battery or a gas-based fuel cell (e.g., a hydrogen fuel cell or methane-based fuel cell, etc.) as an energy source. In addition, the fuel cell may use various types of gas capable of generating electric energy, and the gas may be filled into the vehicle 100 in a liquefied state, for example. Here, the gas may be hydrogen as an example. However, the gas is not limited thereto, and various gases (e.g., ammonia, methane, or natural gas, etc.) may be applied. In the case of fossil energy, the vehicle 100 is driven by fuel such as gasoline, diesel, or liquefied gas, and may be equipped with an internal combustion engine that drives an actuator 114 by combustion of the fuel. The engine may be included in a power source unit 112 from the viewpoint of providing a driving rotational force of a wheel. As another example, the vehicle 100 may drive the actuator 114 by selectively utilizing the energy of the fossil energy-based internal combustion engine and the electric battery, which may be a hybrid type vehicle (e.g., a plug-in hybrid car, mild hybrid SUV, or hybrid truck, etc.).

The vehicle 100 may refer to a moveable device. The vehicle 100 is a ground vehicle that drives on the ground and may be a conventional passenger or commercial vehicle, a Purpose Built Vehicle (PBV), or the like. The vehicle 100 may be a four-wheeled vehicle, such as a passenger car, an SUV, a small truck, or may be a vehicle with more than four wheels, such as a bus, a large truck, a container carrying vehicle, a heavy-equipment vehicle, and the like. The vehicle 100 may be a robot in a broad sense, such as a moving means, and the robot may be moved using wheels, tracks, or other moving modules (e.g., crawler belts, omni-directional wheels, or articulated legs, etc.).

The vehicle 100 may be controlled to be driven by manual driving or autonomous driving due to the driving of a user. The autonomous driving may be implemented as semi-autonomous driving or fully autonomous driving. The fully autonomous driving may be provided as autonomous driving in which a processor 118 of the vehicle 100 completely controls without user intervention even when the driving situation is uncertain (e.g., poor weather, heavy traffic, or road construction, etc.). The semi-autonomy driving may be provided by autonomous driving in which driver intervention is required according to a specific driving situation (e.g., merging lanes, emergency braking, or unmarked intersections, etc.). The semi-self-driving may be implemented such that the processor 118 switches the control to the user while deactivating the autonomous driving when the above situation occurs, thereby causing the user to perform manual driving. According to the level of autonomous driving defined by the American Society of Automotive Engineers (SAE), the semi-autonomous driving may correspond to the autonomous driving levels 1 to 4, and the fully autonomous driving may correspond to level 5.

The vehicle 100 may communicate with other devices 200 and 300 or another vehicle 400. The other devices may include, for example, a server 200 that supports various controls, state management, and driving of the vehicle 100, an intelligent transportation system (ITS) device 300 for receiving information from the ITS, various types of user devices, and the like. The server 200 is, for example, an external device operated by a vehicle manufacturer or provided for servicing a driving support function and may receive connected data of the vehicle 100 or transmit data necessary for manual and autonomous driving. The server 200 may transmit various information and software modules used for controlling the vehicle 100 to the vehicle 100 in response to requests and data transmitted from the vehicle 100 and a user device, so as to support driving and various services of the vehicle 100 (e.g., over-the-air (OTA) updates, remote diagnostics, or navigation map updates, etc.).

The ITS device 300 is, for example, a Roadside Base Station (RSU), and the ITS device 300 may mutually exchange vehicle recognition data, driving control and state data, environmental data around the vehicle, map data, and the like via V2I with the vehicle 100 to assist the user in driving the own vehicle or support autonomous driving of the vehicle 100 (e.g., by providing traffic-light status, road hazard alerts, or construction-zone information, etc.). The vehicle 100 may mutually exchange the above-listed data via V2V with the other vehicle 400 to support manual driving or autonomous driving (e.g., for cooperative lane merging, platooning, or collision avoidance, etc.).

The vehicle 100 may communicate with other vehicles or other devices based on cellular communication, Wireless Access in Vehicular Environment (WAVE) communication, Dedicated Short Range Communication (DSRC) or near field communication, or other communication schemes (e.g., Bluetooth, Ultra-Wideband (UWB), or satellite-based communication, etc.).

For example, the vehicle 100 may use as a cellular communication network such as a communication network such as LTE, 5G, 6G, a WiFi communication network, or a WAVE communication network for communication with the server 200, the ITS device 300, and the other vehicle 400. For another example, a DSRC or the like used in the vehicle 100 may also be used for communication between vehicles. A communication manner between the vehicle 100, the server 200, the ITS device 300 and another vehicle 400 and a user device is not limited to the foregoing example.

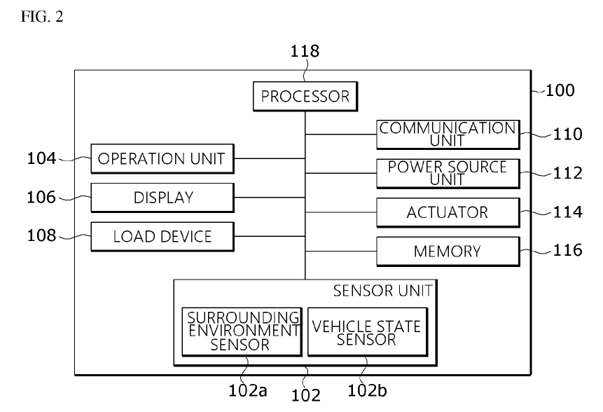

FIG. 2 shows exemplary modules that constitute the vehicle according to an example of the present disclosure.

The vehicle 100 may include a sensor unit 102, an operation unit 104, a display 106, a load device 108, and a communication unit 110.

The sensor unit 102 may include various types of sensors for sensing various states and situations occurring in the external surrounding environment of the vehicle 100, an internal system, the position of the vehicle 100 and user operation and boarding space.

The sensor unit 102 may include a surrounding environment sensor 102a that recognizes dynamic and static objects present in the surroundings of the vehicle 100 and a vehicle state sensor 102b that detects a vehicle state.

The surrounding environment sensor 102a generates sensor data for recognizing an object state around the vehicle, and may include, for example, an externally-oriented camera (e.g., monocular, stereo, or surround-view camera, etc.), a radar sensor (e.g., long-range radar, short-range radar, or corner radar, etc.), and an ultrasonic sensor (e.g., front parking sensor or rear obstacle detector, etc.). The object state is related to behavior states of various objects and may include a class (or type) of the object, a relative position of the object, and a relative speed of the object, for example. However, the object state is not limited to the above and may include various states related to the behavior of the object (e.g., object acceleration, orientation, or trajectory prediction, etc.).

The camera may recognize an external object as an image during use of the vehicle 100 to generate image data and transmit the image data to a processor. The camera may be mounted on a specific site of the vehicle 100, for example, a front site, a rear site, and a side site of the vehicle 10 (e.g., front grille, side mirror, or tailgate, etc.). When a plurality of cameras are mounted on each site, it may be referred to as a multi-camera.

The radar sensor may emit radio waves of a specific frequency around the vehicle 100 to generate radar data via the radio waves reflected from an external object, so as to grasp the presence and relative distance, speed, direction, and the like of the external object. The ultrasonic sensor may emit ultrasonic waves around the vehicle 100 to generate ultrasonic data via the signals reflected from an external objects, so as to identify the presence and the relative distance of the external object present in a short distance (e.g., parking assist or collision warning, etc.).

The surrounding environment sensor 102a may further include a lidar sensor, but in other examples, the lidar sensor may not be mounted on the vehicle 100. The lidar sensor may generate point cloud data as recognized data of an external object and transmit the point cloud data to a processor to generate three-dimensional spatial information identifying at least the shape of the external object (e.g., pedestrian, curb, or surrounding vehicle, etc.).

The vehicle state sensor 102b may include at least one sensor that detects a vehicle state. The vehicle state may include operation states of various vehicles 100. The operation states of the vehicle 100 include, but are not limited to, a longitudinal control state of the vehicle 100, a transverse control state of the vehicle 100, a position of the vehicle 100, a driving state of an actuator 114, an energy remaining amount of a power source unit 112, an operation state of the power source unit 112, a communication state with an external device; a communication network state between components of the vehicle 100 and a control request state due to an operation signal generated by the operation unit 104, and the like (e.g., steering input, throttle position, or battery SOC level, etc.). The longitudinal control state is a longitudinal operation state of the vehicle, and may include, for example, a speed, an acceleration, and the like. The transverse control state is a transverse operation state of the motor vehicle 100 and may include a posture of the vehicle 100 due to steering, a steering angular velocity, a steering angular acceleration, or the like.

The vehicle state sensor 102b for checking the transverse control state may include a posture sensor and a wheel sensor. The posture sensor may detect, for example, states of three axes of the vehicle 100, such as yaw, pitch, and roll, and output various posture states of the vehicle based on the above-described factors. The posture sensor, for example, may be configured as an IMU sensor, a gyro sensor, or the like (e.g., accelerometer-based IMU, MEMS gyro, or optical gyro, etc.). The processor 118 may generate posture data based on the posture state. The wheel sensor may, for example, detect a wheel rotation angle, a wheel rotation angular velocity, and the like.

The vehicle state sensor 102b for confirming the longitudinal control state may include a wheel sensor and a brake sensor. The wheel sensor may detect, for example, a wheel speed and a wheel acceleration of the wheel, and the brake sensor may detect a braking degree of the brake (e.g., brake pedal position, hydraulic pressure, or regenerative braking torque, etc.).

In addition, the vehicle state sensor 102b for confirming the position of the vehicle 100 includes a positioning sensor, and the positioning sensor is, for example, but not limited to, a GPS sensor or a GNSS sensor (e.g., real-time kinematic (RTK) GPS or differential GNSS, etc.). The present disclosure mainly describes the sensors of the sensor unit 102 referred to in this example, and may further include a sensor that senses various situations not listed here (e.g., temperature, humidity, tire pressure, or cabin CO₂ concentration, etc.).

The operation unit 104 may be configured as a module for a user to control for driving. For example, the operation unit 104 may include a steering wheel for manual driving, an automatic or manual transmission actuator, an accelerator pedal, a brake pedal, a gear transmission, or the like. The operation unit 104 further includes an interface for use, release, and selection of detailed functions of an autonomous driving mode requested by the user, so that the user uses the autonomous driving function (e.g., cruise mode, lane-keeping mode, or parking assist mode, etc.). The operation unit 104 may be configured as, for example, a hard-type interface provided at a predetermined position inside the vehicle 100 or a soft-type interface touchable on the display 106, so as to receive various requests related to autonomous driving.

The display 106 may function as a user interface. The display 106 may display, by the processor 118, an operation state of the vehicle 100, a control state, path/traffic information, remaining energy information, content requested by a driver, and the like to be output (e.g., speed, navigation map, or infotainment content, etc.). In addition, the display 106 may be configured as a touch screen capable of detecting driver input and may receive a request of the driver instructing the processor 118. For example, the processor 118 may control the display 106 to provide navigation. For example, a navigation may include real-time route optimization, charging station locations, or road congestion information, etc. The navigation may generate route guidance information based on a route request message by a user or a request of the processor 118. The navigation may generate the route guidance information by using map information stored in the memory 116 or the server 200.

The load device 108 is mounted on the vehicle 100 and may be a type of non-driving electric device excluding a driving power system such as a wheel driving unit (not shown). The load device 108 may be an auxiliary device that receives power from the power source unit 112, and may be, for example, an air conditioning system, an indicator lamp system, a lighting system, a seat system, and various devices installed in the vehicle 100 (e.g., an infotainment system, heated seat, or window regulator, etc.).

The communication unit 110 may support mutual communication with the server 200, the ITS device 300, the surrounding vehicle 400, and the like. For example, the communication unit 110 may include a module that processes cellular communication, WAVE, DSRC communication, and the like (e.g., 5G-V2X, Wi-Fi 6E, or satellite-based channel, etc.). In the present disclosure, the transmission/reception unit 116 may transmit data generated or stored during driving to the server 200 in the form of a signal and receive data and a software module transmitted from the server 200 in a specific type of signal.

The communication unit 110 may support communication for transmitting or receiving signals related to data, control, commands, and requests between the components in FIG. 2 (e.g., between the processor, actuator, and sensor modules, etc.). The components may be devices or modules referred to as reference numerals 102 to 118 illustrated in FIG. 2, for example. The communication unit 110 transfers signals transmitted between the components, that is, signals related to data, control, commands, and requests, to a communication bus by using Controller Area Network (CAN) communication, for example, and may transmit the signals to a specific component. Data, control, command, and requests transferred through CAN communication may be referred to as CAN data.

The communication unit 110 may support communication with an electronic device carried by a passenger inside the vehicle 100 (e.g., a smartphone, smartwatch, or tablet PC, etc.). In the present disclosure, the vehicle 100 may transmit and receive data utilized in the method according to the present disclosure to and from the outside via the communication unit 110.

The vehicle 100 may also include a power source unit 112 and an actuator 114.

The power source unit 112 may generate and supply power and electric power to be used for a driving power system and a non-driving power system, such as the actuator 114. The non-driving power system may be, for example, the sensor unit 102, the operation unit 104, the display 106, the load device 108, the communication unit 110, and the like, and is not limited thereto, and may include various components that implement sensing, interface, communication, and convenience functions except for components directly involved in a driving operation (e.g., infotainment processors, interior lighting, or ventilation systems, etc.).

When the vehicle 100 is driven on an electric energy basis, the power source unit 112 may be configured with, for example, an electric battery that is charged from the outside, or may be configured with a combination of an electric battery and a fuel cell that charges the battery (e.g., lithium-ion battery combined with hydrogen fuel cell stack, etc.). In the case of a combination of the electric battery and the fuel cell, the power source unit 112 may include a tank that stores a material used to generate electric power of the fuel cell, such as liquefied hydrogen (e.g., liquid H₂ or compressed hydrogen gas, etc.). When the vehicle 100 may be driven on a fossil energy basis, the power source unit 112 may include an internal combustion engine. Further, when the vehicle 100 is of a hybrid type, the power source unit 112 may be provided by a combination of the internal combustion engine and the electric battery.

The actuator 114 includes at least one module that implements a driving operation and may execute the driving operation based on a user request from the operation unit 104 or a signal according to a request of the processor 118. The signal according to the request may be related to at least one of longitudinal control such as acceleration and deceleration, transverse control such as steering, and gear shift, for example (e.g., torque command, steering angle request, or gear ratio selection, etc.). Here, the gear shift may be processed by a request of a manual driving user using a gear transmission or the processor 118 in autonomous driving.

The actuator 114 may include a wheel driving unit, a mechanical component and an electronic module for implementing a driving operation on the wheel driving unit, so as to implement a driving operation depending on a command of the processor 118 by a user's manual operation or autonomous driving (e.g., drive motor, power inverter, or steering actuator, etc.). When the vehicle 100 is operated based on electric energy, it may include an assembly for transmitting a requested driving operation to the wheel driving unit 118. When the vehicle is operated based on fossil energy, the actuator 114 may include a transmission and a gear module for transmitting power of an internal combustion engine.

The wheel driving unit may include a plurality of wheels, a driving force generation module for generating a driving force and applying it to the wheels or transmitting the driving force, a braking module for decelerating driving of the wheels, and a steering module for realizing transverse control of the wheels (e.g., electric power steering, brake-by-wire, or active suspension control, etc.). When the vehicle 100 is driven based on electric energy, the driving force generation module may be configured as a motor assembly that generates a driving force based on power output from an electric battery. When the vehicle is driven based on fossil energy, the driving power generation module may be an engine or a transmission assembly. The braking module of the electric-based vehicle 100 may further have a regenerative braking function.

The vehicle 100 may also include a memory 116 and the processor 118.

The memory 116 may store an application for controlling the vehicle 100 and various data and load the application or read and write the data depending on a request of the processor 118. In the present disclosure, the memory 118 may store an application and at least one instruction for generating a vehicle control command for performing autonomous driving based on an object state around the vehicle 100 and a vehicle state, and determining a control command (or a control command signal) of the actuator 114 depending on whether the vehicle control command meets an allowable control command.

Autonomous driving for generation of vehicle control commands may be implemented by a model stored in at least one of the memory 116 or the server 200. The model for autonomous driving may be built to perform cognition, driving plan establishment, control of the actuator 114 (e.g., object recognition, lane tracking, and braking control, etc.). The autonomous driving model may be provided based on machine learning (e.g., a deep neural network, convolutional neural network, or reinforcement learning policy, etc.). The autonomous driving models may process processes such as cognition, plan establishment, and control in separate modules, or process the processes in a single neural network.

The data and model associated with the allowable control command may be used to set the control command of the actuator 114 based on the object state and the vehicle state. The data and model may be retained in the memory 116. The allowable control command may, for each of a plurality of data sets including the object state and vehicle state, be a control command provided to perform safe autonomous driving (e.g., maintaining safe distance, limiting steering rate, or controlling deceleration range, etc.). Further, when autonomous driving depending on the vehicle control command is determined to be faulty, the allowable control command may be a control command used to ensure safe autonomous driving before the driving control is switched to the user, i.e., before switching of manual control. Details associated with allowable control commands will be described below.

The vehicle 100 may receive the autonomous driving model trained by the server 200, the data and the model related to the allowable control command from the server 200 and embed them in the memory 116 to be controlled by the model and the data.

The processor 118 may perform overall control of the vehicle 100. The processor 118 may be configured to execute an application and a command stored in the memory 116. The processor 118 may generate, depending on a driving control request in manual driving and autonomous driving, a signal related to control for a component of the vehicle 100, The component may be at least one of various members described in FIG. 2. The processor 118 may include, for example, at least one of a central processing unit (CPU), a graphical processing unit (GPU), and a neural processing unit (NPU) (e.g., ARM-based CPU, NVIDIA GPU, or AI accelerator chip, etc.). The processor 118 may function as a controller in another example. The controller includes the above processing unit, a cache memory, a bus interface, and the like, and may be, for example, an electric control unit (ECU). The autonomous driving model may be loaded from the memory 116 and executed in the ECU. The controller is not limited to the above example and may be various control units related to control of a specific function of the vehicle (e.g., brake control ECU, motor control ECU, or steering ECU, etc.).

Relating to the present disclosure, the processor 118 may execute processing to generate a vehicle control command (e.g., braking torque, steering angle, or gear selection, etc.) that controls an actuator of the vehicle based on an object state and a vehicle state around the vehicle 100 (e.g., relative distance/speed, lane position, or yaw rate, etc.). The processor 118 may perform processing to determine whether the vehicle control command meets an allowable control command set (e.g., a vehicle control command falling within an allowable control command range) according to the object state and the vehicle state. Further, based on the vehicle control command not meeting the allowable control command, the processor 118 may implement processing to control the actuator of the vehicle 100 based on the allowable control command (e.g., clamp to an upper-limit or lower-limit value, etc.). Details of the above-described processing will be described later.

The processor 118 is illustrated as being configured as a single processing module, as in FIG. 2, to execute the above processing. In another example, the processor 118 may be configured as a plurality of processing modules, and the above processing may be distributed and processed in the plurality of modules (e.g., separate sensor fusion unit, decision-making unit, and actuator control unit, etc.). In yet another example, the processer 118 may cooperate with the server 200 to perform the above processing in a distributed manner (e.g., cloud-based model inference or remote diagnostic computation, etc.).

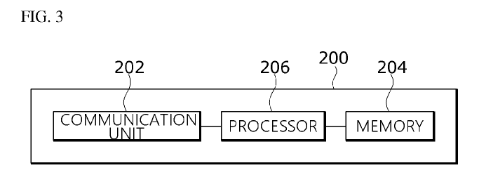

FIG. 3 shows exemplary modules that constitute a server according to the present disclosure.

The server 200 may include a communication unit 202, a memory 204, and a processor 206.

The communication unit 202 transmits and receives data to and from an external device, supports mutual communication with the vehicle 100 in the present disclosure, and may exchange data with the vehicle 100 (e.g., software updates, vehicle diagnostics, or fleet management data, etc.).

The memory 204 may store an application for operating the server 200 and various data and load the application or read and write data depending on a request of the processor 206. In the present disclosure, the memory 204 may manage data and models related to an autonomous driving model and an allowable control model built in the vehicle 100 (e.g., trained neural network parameters, calibration data, or safety threshold maps, etc.).

The processor 206 may perform overall control of the server 200. The server 200 may be configured to execute an application and instructions stored in the memory 204. The processor 206 executes the application to process and respond to a user's request transmitted from the vehicle 100 (e.g., route optimization, firmware verification, or remote-control authorization, etc.).

The processor 206 is illustrated in the present disclosure as being configured as a single processing module. In another example, the processor 206 may be distributed to a plurality of processing modules, and the above processing may be executed by a distributed processing model (e.g., edge-cloud hybrid processing or multi-node data fusion, etc.).

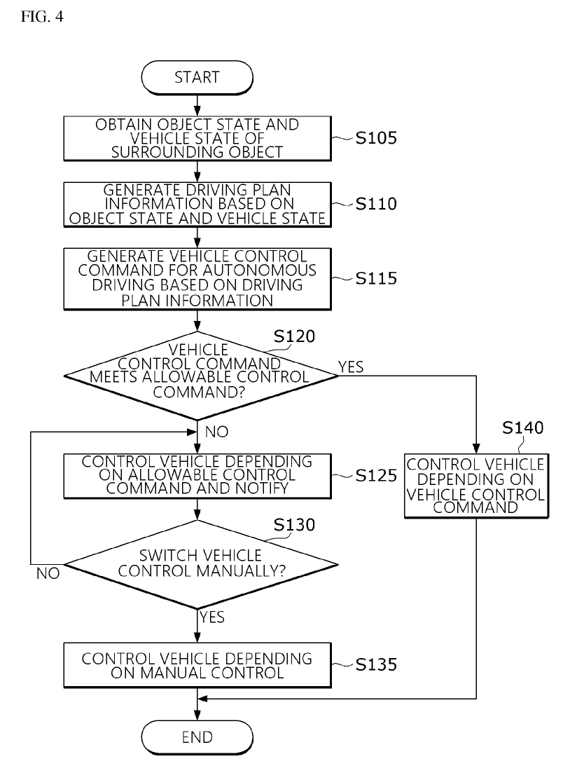

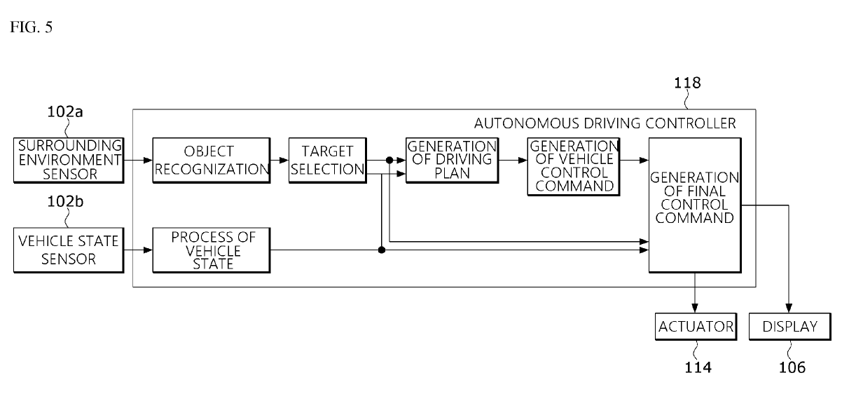

Hereinafter, a vehicle control method according to another example of the present disclosure will be described in detail with reference to FIGS. 4 and 5. FIG. 4 shows an example of a vehicle control method according to another example of the present disclosure. FIG. 5 shows an example of a vehicle control process. In the present disclosure, the method is performed by the processor 118, but for convenience of description, the processor 118 and the vehicle 100 may be described in combination.

In S105 of FIG. 4, the processor 118 of the vehicle 100 may receive sensor data that detects an object around the vehicle and an operation situation of the vehicle from the sensor unit 102, and obtain, based on the sensor data, an object state and a vehicle state (e.g., relative distance to a preceding vehicle, road curvature, or vehicle speed, etc.).

Step S105 may be performed by the autonomous driving controller illustrated in FIG. 5. The autonomous driving controller may be implemented in the processor 118 (e.g., an ECU or a domain controller dedicated to perception and planning, etc.).

Referring to FIG. 5, in the process of S105, the processor 118 may recognize an object in the sensor data obtained from the surrounding environment sensor 102a. The object recognition may be performed by the autonomous driving model (e.g., an object-detection neural network or a sensor fusion-based classifier, etc.). The surrounding environment sensor 102a may include, for example, at least one of a camera, a radar sensor, an ultrasonic sensor, and a lidar sensor (e.g., forward radar, rear camera, or roof-mounted lidar, etc.).

Specifically, the processor 118 may fuse at least two sensor data of image data, radar data, ultrasound data, and point cloud data into a common space (e.g., a 3D voxel map or bird’s-eye view coordinate frame, etc.). The processor 118 may track tracks while managing objects recognized in the fused space, such as surrounding vehicles and pedestrians, by track.

The processor 118 may generate track information for each track, based on sensor data of the surrounding environment sensor 102a. The track information for each object may include an object state. The processor 118 may output the object state based on a sensor output signal included in the sensor data. In the present disclosure, the object state may also be referred to as object state information. The object state may include at least one object data related to behavior states of various objects. The object data may include, for example, a relative position of a class object of the object, a relative speed of the object, and the like (e.g., heading angle, predicted motion vector, or acceleration pattern, etc.). However, the object state is not limited to the above and may include various states related to the behavior of the object. With the above, the recognition of the object may be processed to have the object data for each track.

The sensor data related to the vehicle state may be obtained from the vehicle state sensor 102b. The vehicle state sensor 102b may include, for example, a posture sensor, a wheel sensor, a brake sensor, and a positioning sensor (e.g., IMU, wheel speed encoder, brake pressure sensor, or GPS module, etc.). The processor 118 may execute processing of generating the vehicle state based on the sensor data obtained from the vehicle status sensor 102b. For example, the processor 118 may perform preprocessing such as filtering on the sensor data of the vehicle state sensor 102b (e.g., Kalman filtering, low-pass filtering, or sensor fusion smoothing, etc.), and generate operation data based on the preprocessed sensor data.

The vehicle state may include at least one operation data associated with operational states of the various vehicles 100 (e.g., speed, acceleration, steering angle, or battery voltage, etc.). In the present disclosure, the vehicle state may also be referred to as vehicle state information. The operation data may include, for example, a longitudinal control state of the vehicle 100, a transverse control state of the vehicles 100, a position of the vehicle 100 and a driving state of the actuator 114, etc. Although not listed here, the operational states may include the states illustrated in the description of FIG. 2. The longitudinal control state corresponds to a longitudinal operational state and may include, for instance, a speed, an acceleration, etc. The transverse control state is a transverse operational state and may, for instance, include a posture, a steering angular velocity, a steering angular acceleration, etc. of the vehicle 100 due to steering. The longitudinal and transverse control states may be transmitted, for instance, in the form of a CAN signal between the sensor unit 102 and the processor 118. The CAN signal associated with the longitudinal control state and transverse control state may be a vehicle dynamics signal (e.g., acceleration request signal or yaw rate feedback signal, etc.).

At S110 of FIG. 4, the processor 118 may generate driving plan information based on the object state and the vehicle state (e.g., lane-level path, velocity profile, or merging decision, etc.).

Referring to FIG. 5, in the process of S110, the processor 118, such as the autonomous driving controller, may use the autonomous driving model to select a recognized object, i.e., a track required in the current driving situation, as a target (e.g., a leading vehicle in the same lane or a pedestrian in a crosswalk, etc.).

The processor 118 may generate driving plan information depending on a current driving situation based on an object state and a vehicle state of a target selected by using the autonomous driving model. The driving plan information may include local predicted trajectory information of the vehicle 100 (e.g., target waypoints, speed constraints, or predicted time-to-collision, etc.). The driving plan data may be described in various formats such as waypoints, trajectories, motion vectors, and motion control.

At S115 of FIG. 4, the processor 118 may generate, by the autonomous driving controller illustrated in FIG. 5, a vehicle control command for autonomous driving based on the driving plan information (e.g., throttle/brake torque, steering angle, or gear shift signal, etc.).

The vehicle control command is a command for controlling the actuator 114 to implement an operation of the vehicle depending on the driving plan information and may be a command including at least one of a longitudinal control and a transverse control (e.g., acceleration, braking, or steering control, etc.). For example, the command related to the longitudinal control is acceleration, braking deceleration, or the like, and may be transmitted in the form of a signal to a driving force generation module or a braking module of the actuator 114 (e.g., motor torque control signal or hydraulic brake pressure command, etc.). In addition, the command related to the longitudinal control is a request signal generated in the module for implementing acceleration or deceleration. The request signal is, for example, but not limited to, a signal related to a motor torque, a shift parameter of a transmission, and a brake application degree (e.g., regenerative braking request, clutch torque command, or downshift signal, etc.). The command related to the transverse control is a steering angle, a steering angular velocity, or the like and may be transmitted to a steering module of the actuator 114 (e.g., electric power steering module or steer-by-wire actuator, etc.). The vehicle control command may be transmitted to corresponding component of the actuator 114 in a control signal form (e.g., via a CAN message, LIN signal, or Ethernet frame, etc.).

In the present disclosure, for the convenience of description, the longitudinal control related to braking among the control types of various actuators of autonomous driving will be exemplarily described.

In S120 of FIG. 4, the processor 118 of the vehicle 100 may determine whether the vehicle control command meets the allowable control command set (e.g., allowable control command range) according to the object state and the vehicle state. The process of S120 may be performed through the determination function of the final control command in the autonomous driving controller illustrated in FIG. 5 (e.g., by comparing predicted control outputs with predefined safety envelopes, etc.).

The allowable control command may be determined using a Model Predictive Control (MPC) that employs an object state and a vehicle state as multiple inputs and outputs a control command value (e.g., target braking torque or steering rate, etc.). As described above, the object state may include at least one object data, and the vehicle state may include at least one operation data.

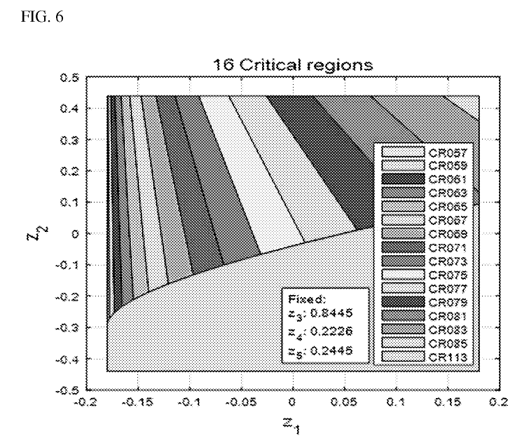

The MPC for determining the allowable control command may be implemented to provide (or output) preset control command information depending on the object state and the vehicle state, as illustrated in FIG. 6. FIG. 6 shows an example of an admission control instruction. FIG. 6 illustrates an explicit Model Predictive Control (Explicit MPC) in which the preset allowable control command is schematized in a map form (e.g., a lookup table indexed by vehicle speed and relative distance, etc.).

The explicit MPC may be a method that utilizes a preset control law to reduce the computational complexity of general MPC and improve real-time applicability. While the general MPC solves an optimization problem in real time to derive a control input, explicit MPC may pre-calculate a solution (or a command value) of the optimization problem offline based on the state space of the system, store it as a multi-section control law, and utilize it for real-time control (e.g., real-time selection of torque or steering gain from precomputed regions, etc.).

Specifically, with respect to the construction of the explicit MPC, the explicit MPC may be established based on modeling in a state space including an object state and a vehicle state, so that a vehicle that is a target of main control logic may be modeled (e.g., longitudinal braking dynamics or lateral path-following dynamics, etc.). The main control logic may, for example, be logic for generating a vehicle control command by an autonomous driving model (e.g., by computing target acceleration or steering curvature, etc.). Next, a range of input values used in the main control logic is identified, and a control command value corresponding to the input value may be generated via analysis of the model state. A model for explicit MPC may be established in advance by generating a map representing a correlation between the input value and the control command value so that the control command value meets a safe range for the entire range of input values (e.g., ensuring braking limits, tire slip thresholds, or steering rate bounds, etc.). Such a map is illustrated in FIG. 6.

The memory 116 stores a preset map (i.e., data obtained by sorting or schematizing preset control command values depending on an object state and a vehicle state) for use in determining the allowable control command, and the processor 118 may refer to the map stored in the memory 116 to determine the allowable control command (e.g., by interpolating between regions of the map to obtain a command value, etc.).

As an example, the allowable control command may be determined as a control command value corresponding to an object state and a vehicle state with reference to a map as shown in FIG. 6. The allowable control command (i.e., the control command value) according to the explicit MPC illustrated in FIG. 6 may be determined by state variables Z₁, Z₂, Z₃, Z₄, and Z₅corresponding to input values (e.g., relative distance, relative speed, vehicle velocity, road friction, or slope, etc.). As an example, when Z₁, Z₂, Z₃, Z₄, and Z₅ are 0.1, -0.3, 0.8, 0.2, and 0.2, respectively, the allowable control command may be 0.1 in U_{CR113}belonging to CR113.

In another example, the allowable control command may be provided in a range of control command values having an extended safety range (e.g., ±10% torque tolerance or deceleration band adjustment, etc.). With respect to the provision of allowable control commands, the processor 118 may analyze the main control logic to have a margin of command control values, thereby identifying the input values that have the greatest impact on the generation of control command values. In particular, high-priority data selected depending on the type of control of the actuator among the object data and the operation data may be identified. The high-priority data may be the input values that are maximally referenced or accounted for in the generation of the control command values of the particular control type (e.g., relative distance for braking control or steering angle rate for lateral control, etc.).

Next, the processor 118 may apply a margin of a predetermined range to the input value corresponding to the high-priority data, and determine, with reference to the map utilized in the explicit MPC, the range of the control command value corresponding to the input value range having the predetermined margin as the allowable control command. The margin applied to the input value may be, for example, from +10% to −10% (e.g., to accommodate model uncertainty, sensor noise, or actuator delay, etc.). The extended safety range includes an upper limit and a lower limit of the control command values defined in the map for the margin range of the input values corresponding to the high-priority data and may simultaneously ensure a minimum margin of safety and autonomous driving control.

In another example, the processor 118 may directly apply a margin to the control command values of the map of the initial model for which the high-priority data is used as a variable, without applying a margin to the high-priority data, to provide an allowable control command having an extended safety range (e.g., directly scaling the torque or steering command bounds, etc.). Accordingly, control commands having an upper limit and a lower limit may be provided for each particular input value associated with the high-priority data.

Taking FIG. 6 as an example, when Z₃ is the high-priority data, the allowable control command may be a range of control command values corresponding to a margin range of Z₃(e.g., ±10 % variation in relative speed, etc.)_{.}

Next, the processor 118 of the vehicle 100 may determine whether the vehicle control command meets the allowable control command depending on the object state and the vehicle state (e.g., by comparing predicted braking torque or steering rate with safety bounds, etc.).

Taking longitudinal control related to braking as an example among various types of control of actuators in autonomous driving, an object state may include a relative position of an object and a relative speed of the object (e.g., distance and velocity of a preceding vehicle, etc.). The object may be, for example, a surrounding vehicle or a vehicle selected as a target in an autonomous driving model. A longitudinal operation state related to a vehicle state may include, for example, the speed and longitudinal acceleration of the vehicle 100 depending on a wheel speed (e.g., vehicle traveling at 60 km/h with 0.5 m/s² acceleration, etc.). A transverse operation state related to the vehicle state may include, for example, an attitude of the vehicle 100 due to steering, and the attitude of the vehicle may be a yaw rate (e.g., 5 deg/s during a lane change, etc.).

Since the control logic for generating the vehicle control commands related to braking uses the relative position of the object, the relative speed of the object, a speed of the vehicle, an acceleration of the vehicle, and a yaw rate of the vehicle, the input values may include the relative position, the relative speed, the speed of the vehicle, the acceleration of the vehicle, and the yaw rate (e.g., five-dimensional state vector inputs to the MPC model, etc.). The range of each input value may be a range in which the vehicle 100 and the system based on the autonomous driving model may operate (e.g., 0–40 m for relative distance, −5 to 5 m/s for relative speed, etc.). The braking control command values may be generated in advance in the form of a map in the safety range, for the entire range of each variable input value in the vehicle and the system (e.g., lookup table correlating speed–distance pairs with deceleration limits, etc.).

The processor 118 may refer to a map stored in the memory 116 to determine an allowable control command related to braking by autonomous driving. The processor 118 may identify high-priority data (state variable or input value) having the highest influence on the braking control command value based on the autonomous driving model related to the longitudinal control related to braking. In this example, the high-priority data may be the relative speed of the object. The processor 118 may apply a margin of a predetermined range to the relative speed of an object corresponding to the high-priority data (e.g., ±0.1 m/s variation for sensor uncertainty, etc.). The processor 118 may refer to a map utilized in explicit MPC to determine a range of braking control command values corresponding to a range of relative speeds having a predetermined margin as the allowable control command (e.g., computing deceleration bands between upper and lower limits, etc.).

As a more specific example, the relative position of a surrounding vehicle (target vehicle) selected as a target may be 2 m and 1 m in the longitudinal direction and the transverse direction, respectively, and the relative speed of the target vehicle may be -1m/s². The speed of the vehicle 100, the longitudinal acceleration of the vehicle 100 and the yaw rate of the vehicle 100 may be 16 m/s, 1 m/s² and 5 deg/s, respectively. The processor 118 may generate the relative speeds −1.1 m/s² to −0.9 m/s² having a margin by applying a margin of +/−10% to the relative speed of a target vehicle corresponding to the high-priority data. The processor 118 may determine, as the allowable control command, a range of the braking command control value corresponding to a range of the relative speed from −1.1 to −0,9 m/s² in the map. The allowable control command may be determined as a braking command control value having a lower limit of −3.1 m/s² and an upper limit of −2.8 m/s² by the map.

When the vehicle control command related to braking is generated at −2 m/s²,the processor 118 may determine that the vehicle control command does not meet the allowable control command. Although the processing related to the generation and comparison of the vehicle control command and the allowable control command is described in this example with a focus on braking among the control types of autonomous driving, it may be applied to other control types, such as steering, driving, and the like (e.g., steering angle limit control or traction torque adjustment, etc.).

Referring to S125 of FIG. 4, the processor 118 of the vehicle 100 may control the actuator 114 of the vehicle 100 according to the allowable control command based on the vehicle control command not meeting the allowable control command, and may generate a message notifying of a fault of autonomous driving and notify the user (e.g., dashboard warning, audible alert, or HMI message, etc.).

The processor 118 may determine, based on the vehicle control command not meeting the allowable control command, that there is a fault or failure in the autonomous driving depending on the vehicle control command.

The processor 118 may, in response to a faulty in autonomous driving, compare the vehicle control command to the upper and lower limits of the allowable control command without sending the vehicle control command to the actuator 114. The processor 118, in response to the vehicle control command being greater than the upper limit of the allowable control command, may determine the allowable control command having the control command value of the upper limit to be a final control command and control the actuator 114 with the final control command. Alternatively, the processor 118, in response to the vehicle control command being less than the lower limit of the allowable control command, may determine the allowable control command having the control command value of the lower limit to be a final control command and control an actuator 114 with the final control command (e.g., clamping deceleration to −3.1 m/s² or limiting torque output, etc.).

Taking the longitudinal control related to braking illustrated in S120 as an example of the control type of autonomous driving, the actuator 114 may be a brake module, a motor, or the like, the vehicle control command may be −2 m/s^{2,} and the allowable control command may be a braking command control value having a lower limit of −3.1 m/s² and an upper limit of −2.8 m/s^{2.} In this example, the processor 118 may compare the value of the vehicle control command and the range of the allowable control command to determine that the value of the vehicle control command is greater than the upper limit of the allowable control command. The processor 118 may determine the braking control command value −2.8 m/s² corresponding to the upper limit of allowable control command as a final control command. Otherwise, when the vehicle control command was less than the lower limit of allowable control command, then the processor 118 may determine the braking control command value −3.1 m/s² that corresponds to the lower limit of the allowable control command as a final control command. The final control commands described in the two examples may be transmitted to the actuator 114 by the processor 118, so that the actuator 114 is controlled based on the final control commands.

In addition, the processor 118 may generate a message notifying a fault in autonomous driving and display it on the display 106. The message may further include a request to switch to manual control (or manual driving) of the vehicle 100.

In another example, the processor 118 may provide a voice notification (e.g., a voice alert), a haptic notification (e.g., a vibration), a lighting notification, and the like based on the message.

In S130 of FIG. 4, the processor 118 may determine, based on input from the user who has received the message, whether the control of the vehicle 100 has been switched to manual control. The manual control may include the user directly operating the operation unit 104 including the steering wheel, the accelerator pedal, the brake pedal, and the like to control the vehicle 100.

Based on the processor 118 detecting that control of the vehicle 100 has not been switched to manual control at S130, control of the actuator 114 may be maintained with the allowable control command, and the message may be re-generated and provided to the display 106 (e.g., re-displayed) or the like.

In S135 of FIG. 4, when the processor 118 detects that the control of the vehicle 100 has been switched to manual control, the actuator 114 may be controlled based on an operation signal in the operation unit 104 operated by the user. That is, when the control has been switched to manual control, the processor 118 may control the vehicle 100 based on the manual control.

With reference to S140 of FIG. 4, the processor 118 of the vehicle 100 may determine, in the process of S120, the vehicle control command as the final control command based on the vehicle control command being determined to meet the allowable control command, and control, based on the vehicle control command, the actuator 114 of the vehicle 100. Taking the longitudinal control related to the braking illustrated in S120 as an example of the control type of the autonomous driving, when the vehicle control command belongs to the allowable control commands having a range of -3.1 m/s² to -2.8 m/s², the processor 118 may transmit the braking control command value corresponding to the vehicle control command to the actuator 114, to control the actuator 114.

A method for safety diagnosis of autonomous driving may include a comparator and a majority voter. The comparator may detect a failure and stop performing when a difference of a predetermined value or more occurs between processing results of two independent software modules. The majority voter may determine a final command by using a majority vote among processing values from three or more software modules. Since the comparator may not identify which module is outputting a failure value among the two modules and stops execution of the entire module, it may be difficult to temporarily respond to a failure situation. The majority voter may use excessive memory resources.

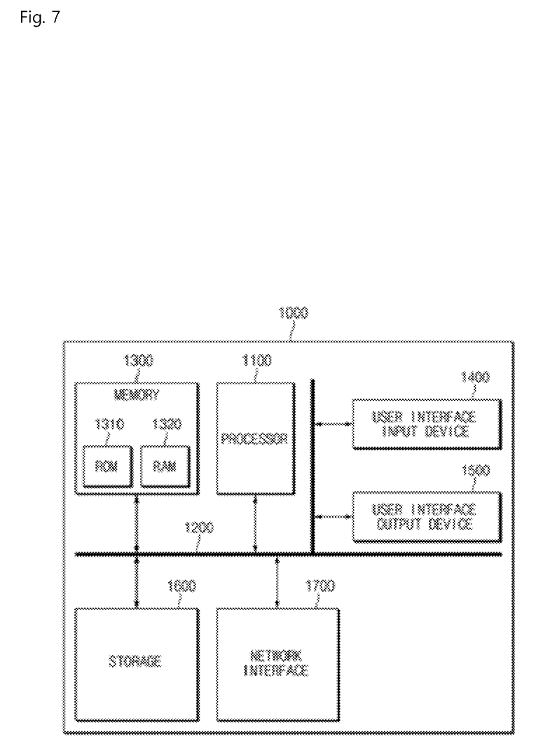

According to the present disclosure, since the vehicle 100 is autonomously controlled with the allowable control command until the vehicle control is switched to manual control, a temporary response to a failure situation is possible. By using a preset explicit MPC manner, real-time operation and memory loads may be reduced or minimized. In addition, general MPC-like performance may be exhibited by directly applying the logic of the MPC using an online control technique. Improved control performance may be realized over other safety control techniques, for example, PID-based fallback control. FIG. 7 shows an example computing system (e.g., a computing device of a vehicle or a server any other apparatus). One or more controllers, processors, etc. described herein, such as one or more components of the vehicle 100, one or more components of the server 200, one or more components of the ITS device 300, another vehicle 400, or any other components and devices disclosed herein, may be implemented by or in the computing system as shown in FIG. 7.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with examples disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, there is provided a vehicle, comprising: a sensor unit that detects object state and vehicle state around the vehicle; a memory that stores at least one command; and at least one processor that executes the at least one command stored in the memory. The at least one processor is configured to: generate a vehicle control command that controls an actuator of the vehicle based on object state and vehicle state around the vehicle; and determine whether the vehicle control command meets an allowable control command set depending on the object state and the vehicle state; and control the actuator of the vehicle depending on the allowable control command based on the vehicle control command not meeting the allowable control command,.

In some implementations, the object state may comprise at least one object data related to behavior state of the object, and the vehicle state may comprise at least one operation data relating to an operational state of the vehicle.

In some implementations, the object state may comprise a relative position of the object and a relative velocity of the object, and the vehicle state may comprise a longitudinal operational state of the vehicle and a transverse operational state of the vehicle.

In some implementations, the allowable control command may be determined using a Model Predictive Control (MPC) that employs the object state and the vehicle state as multiple inputs and outputs a control command value.

In some implementations, the object state may comprise at least one object data related to behavior state of the object, the vehicle state may comprises at least one operation data related to operation state of the vehicle, a predetermined range of margin may be applied to priority data selected depending on a control type of the actuator among the object data and the operation data, and the allowable control command may be set based on the priority data having the applied margin and provided as a control command value having an upper limit and a lower limit.

In some implementations, the at least one processor may, in the control of the actuator of the vehicle depending on the allowable control command, be configured to: control the actuator with the allowable control command having a control command value of the upper limit in response to the vehicle control command being greater than the upper limit of the allowable control command, and control the actuator with the allowable control command having a control command value of the lower limit in response to the vehicle control command being less than the lower limit of the allowable control command.

In some implementations, the allowable control command may be provided as a control command value having an upper limit and a lower limit by applying a margin of a predetermined range to the control command value.

In some implementations, after control of the actuator of the vehicle depending on the allowable control command, the at least one processor may be further configured to: determine whether control of the vehicle has been manually switched; maintain control of the actuator depending on the allowable control command based on the control being manually unswitched; and control the actuator based on manual control based on the control being manually switched.

In some implementations, the vehicle control command may be a control command of the actuator for performing autonomous driving.

In some implementations, the at least one processor may further be configured to generate a message notifying of a faulty of the autonomous driving and requesting manual control of the vehicle, after control of an actuator of the vehicle depending on the allowable control command.

According to another example of the present disclosure, there is provided a method for controlling a vehicle, comprising: generating a vehicle control command that controls an actuator of the vehicle based on object state and vehicle state around the vehicle; determining whether the vehicle control command meets an allowable control command set depending on the object state and the vehicle state; and controlling the actuator of the vehicle depending on the allowable control command based on the vehicle control command not meeting the allowable control command.

According to the present disclosure, it is possible to provide a vehicle that ensures safe driving control with few resources before control switching by manual driving in an abnormal situation of autonomous driving control, and a method for controlling the same.

Effects that may be obtained in the present disclosure are not limited to the above-mentioned effects, and other effects that are not mentioned will be clearly understood by those skilled in the art to which the present disclosure belongs from the description below.

While the exemplary methods of the present disclosure described above are represented as a series of operations for clarity of description, it is not intended to limit the order in which the steps are performed, and the steps may be performed simultaneously or in different order, as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A vehicle comprising:
a sensor configured to detect object state and vehicle state associated with the vehicle;
a processor; and
a memory storing at least one instruction that, when executed by the processor, is configured to cause the vehicle to:
generate, based on the object state and vehicle state, a vehicle control command that controls an actuator of the vehicle,
determine, based on the object state and vehicle state, whether the vehicle control command corresponds to at least one allowable control command of an allowable control command set,
based on the vehicle control command not corresponding to any allowable control command of the allowable control command set, output a signal associated with an allowable control command, and
control, based on the signal, the actuator of the vehicle.

2. The vehicle of claim 1, wherein the object state comprises object data related to at least one behavior state of an object associated with a surrounding environment of the vehicle, and wherein the vehicle state comprises operation data related to at least one operational state of the vehicle.

3. The vehicle of claim 2, wherein the object state comprises a relative position of the object with respect to the vehicle and a relative velocity of the object with respect to the vehicle, and wherein the vehicle state comprises a longitudinal operational state of the vehicle and a transverse operational state of the vehicle.

4. The vehicle of claim 1, wherein the allowable control command is determined using a preset lookup table, and wherein the preset lookup table is indexed by a value of the object state and a value of the vehicle state to provide a control command value.

5. The vehicle of claim 4, wherein:
the object state comprises object data related to at least one behavior state of an object associated with a surrounding environment of the vehicle,
the vehicle state comprises operation data related to at least one operational state of the vehicle,
priority data, based on a control type of the actuator, is selected among the object data and the operation data,
a predetermined range of margin is applied to the priority data, and
the allowable control command is determined based on the priority data with the applied predetermined range of margin and is defined as a control command range having an upper limit value of the allowable control command and a lower limit value of the allowable control command.

6. The vehicle of claim 5, wherein the at least one instruction, when executed by the processor, is configured to cause the vehicle to:
based on a first value associated with the vehicle control command exceeding the upper limit value of the allowable control command, control the actuator using the upper limit value, and
based on a second value associated with the vehicle control command being less than the lower limit value of the allowable control command, control the actuator using the lower limit value.

7. The vehicle of claim 4, wherein the allowable control command is provided as a control command range having an upper limit value and a lower limit value by applying a margin of a predetermined range to the control command value.

8. The vehicle of claim 1, wherein the at least one instruction, when executed by the processor, is configured to cause the vehicle to, after the control of the actuator of the vehicle:
determine whether the control of the vehicle has been switched to a manual control,
maintain, based on the control not being switched to the manual control, control of the actuator using the allowable control command, and
perform, based on the control being switched to the manual control, the manual control of the actuator.

9. The vehicle of claim 1, wherein the vehicle control command comprises a control command of the actuator for performing autonomous driving of the vehicle.

10. The vehicle of claim 9, wherein the at least one instruction, when executed by the processor, is configured to cause the vehicle to, after the performing of autonomous driving of the vehicle, generate a message notifying of a fault in the autonomous driving and requesting a switching to a manual control of the vehicle.

11. A method performed by a vehicle, the method comprising:
generating, based on object state and vehicle state associated with the vehicle, a vehicle control command that controls an actuator of the vehicle;
determining, based on the object state and vehicle state, whether the vehicle control command corresponds to at least one allowable control command of an allowable control command set;
based on the vehicle control command not corresponding to any allowable control command of the allowable control command set, outputting a signal associated with an allowable control command; and
controlling, based on the signal, the actuator of the vehicle.

12. The method of claim 11, wherein the object state comprises object data related to at least one behavior state of an object associated with a surrounding environment of the vehicle, and wherein the vehicle state comprises operation data related to at least one operational state of the vehicle.

13. The method of claim 12, wherein the object state comprises a relative position of the object with respect to the vehicle and a relative velocity of the object with respect to the vehicle, and wherein the vehicle state comprises a longitudinal operational state of the vehicle and a transverse operational state of the vehicle.

14. The method of claim 11, further comprising:
determining the allowable control command based on a preset lookup table, wherein the preset lookup table is indexed by a value of the object state and a value of the vehicle state to provide a control command value.

15. The method of claim 14, wherein the object state comprises object data related to at least one behavior state of an object associated with a surrounding environment of the vehicle, wherein the vehicle state comprises operation data related to at least one operational state of the vehicle, and wherein the method further comprises:
selecting, based on a control type of the actuator, priority data among the object data and the operation data;
applying a predetermined range of margin to the priority data;
determining the allowable control command based on the priority data having the applied predetermined range of margin; and
providing the allowable control command as a control command range having an upper limit value of the allowable control command and a lower limit value of the allowable control command.

16. The method of claim 15, wherein the controlling of the actuator of the vehicle comprises:
based on a first value, associated with the vehicle control command, exceeding the upper limit value of the allowable control command, controlling the actuator using the upper limit value, and
based on a second value associated with the vehicle control command being less than the lower limit value of the allowable control command, controlling the actuator using the lower limit value.

17. A vehicle comprising:
a sensor configured to obtain an object state associated with at least one object in a surrounding environment of the vehicle and a vehicle state of the vehicle;
an actuator configured to perform at least one of steering, braking, or acceleration of the vehicle;
a driving control circuit configured to control autonomous driving of the vehicle; and
a processor circuit configured to:
generate, based on the object state and the vehicle state, a vehicle control signal for controlling the actuator of the vehicle,
determine whether a value of the vehicle control signal is within an allowable control signal range that is preset based on the object state and the vehicle state,
based on the value of the vehicle control signal not being within the allowable control signal range, output a signal satisfying the allowable control signal range, and
control, via the driving control circuit and based on the signal, autonomous driving of the vehicle.

18. The vehicle of claim 17, wherein the processor circuit is configured to determine the allowable control signal range by referencing a map, and wherein the map is generated based on control commands that are pre-determined and stored for real-time lookup of allowable commands.

19. The vehicle of claim 17, wherein the processor circuit is configured to:
identify, among a plurality of state variables associated with the object state and the vehicle state, a highest-priority variable having a greatest impact on the vehicle control signal,
apply a margin to the highest-priority variable, and
determine, based on the applied margin, the allowable control signal range.

20. The vehicle of claim 17, wherein the processor circuit is configured to output a message requesting manual driving of the vehicle and maintain control of the vehicle based on the signal until the manual driving is detected.
